(19) United States
(12) Patent Application Publication
(10) Pub. No.: US 2004/0044472 A1
(43) Pub. Date: Mar. 4, 2004

(54) Vehicle navigation server, and vehicle navigation device and system using the same

(75) Inventors: Masakuni Tsuge, Saitam-shi (JP); Takeshi Imai, Utsunomiya-shi (JP); Toshihide Yofu, Utsunomiya-shi (JP); Hiroyuki Tsuda, Asaka-shi (JP); Kouichi Washimi, Nara-shi (JP)

Correspondence Address: LAHIVE & COCKFIELD, LLP., 28 STATE STREET, BOSTON, MA, 02109, US

(73) Assignee: Honda Giken Kogyo Kabushiki Kaisha, Tokyo (JP)

(21) Appl. No.: 10/643,726

(22) Filed: Aug. 18, 2003

(30) Foreign Application Priority Data
Aug. 28, 2002 (JP) 2002-249658

(51) Int. Cl. G01C 21/34

(52) U.S. Cl. 701/210; 701/202; 340/995.21

(57) ABSTRACT

A vehicle navigation system for selecting a suitable travel route based on transmitted traffic information. A server calculates a proposed travel route based on input data and defines communication points so as to newly extract traffic information for an area from each communication point to the destination from a traffic information storage device, where a point from which a detour around a place noted in the traffic information is included. The server stores data for identifying the registrant, the proposed travel route, and the communication points in a storage device and sends the traffic information and communication points to a vehicle navigation device. The sent traffic information includes detailed information about a section from the current or start position of the vehicle to the closest communication point to the vehicle on the way to the destination and simplified information about a section from this point to the destination.

### BACKGROUND OF THE INVENTION

1. Field of the Invention

The present invention relates to a vehicle navigation server for calculating at least one proposed travel route based on input data such as the current or start position and the destination of a vehicle, extracting traffic information relating to the proposed travel route from a traffic information center, and sending the information to a vehicle navigation device, and to a vehicle navigation server and a vehicle navigation system which use the vehicle navigation server.

2. Description of the Related Art

In recently developed vehicle navigation systems, data of a destination defined and input by a passenger is sent to a navigation server, the server searches for a route to the destination, and data of the route and related information are sent to a vehicle navigation device built into the vehicle.

For example, Japanese Unexamined Patent Application, First Publication No. Hei 10-319840 discloses a technique in which guide points are set in the determined route, and when the vehicle passes a guide point, data relating to the route is sent to the vehicle.

However, conventional techniques have only a function of sending data relating to the determined route, and does not have a function of changing the route according to the sent data. Therefore, when the vehicle running on the determined route receives information about a traffic accident, if the information is received immediately before reaching the place of the accident, the vehicle may not take a detour rather than the determined route. In addition, when a detour route for taking a longer way around the shortest route is once determined in the search for a route to the destination according to traffic regulation information such as accident information, even if the regulation for the shortest route is released during the running of the vehicle, the vehicle may not run in consideration of the release of the regulation.

Also in the conventional techniques, data of the route itself, which was searched for by the server, is also sent to the vehicle navigation device. However, the determined route is map data which contains a large amount of data, and the memory in the vehicle navigation device has a limited capacity. Therefore, when the data of the determined route, received from the server, is stored in the memory, the storage capacity of the memory is greatly reduced, so that the amount of data relating to the determined route (e.g., traffic information), which can be stored in the memory, is considerably limited.

### SUMMARY OF THE INVENTION

In consideration of the above circumstances, an object of the present invention is to provide a vehicle navigation server by which a suitable route of a vehicle can be selected based on traffic information sent from the server, and to provide a vehicle navigation device and a vehicle navigation system which uses the vehicle navigation server.

Therefore, the present invention provides a vehicle navigation server (e.g., a navigation server 5 in an embodiment explained below) comprising:

travel route calculating device (e.g., an arithmetic operation server 14 in the embodiment) for calculating at least one proposed travel route of a vehicle based on data input by a registrant to the server, the data including a current or start position and a destination of the vehicle;

a traffic information extracting device (e.g., the arithmetic operation server 14 and a traffic information server 13 in the embodiment) for extracting traffic information relating to the proposed travel route from a traffic information storage device (e.g., a storage device 16 in the embodiment);

a communication point setting device (e.g., the arithmetic operation server 14 in the embodiment) for defining at least one communication point on the proposed travel route, so as to newly extract traffic information for an area from each communication point to the destination from the traffic information storage device and to send the newly extracted traffic information to a vehicle navigation device (e.g., a vehicle navigation device 8 in the embodiment) built in the vehicle when the vehicle passed the communication point;

a data storage device (e.g., storage devices 16 to 18 in the embodiment) for storing at least data for identifying the registrant, data of said at least one proposed travel route, and data of said at least one communication point, and

a data sending device (e.g., a terminal operation server 15 in the embodiment) for sending at least the traffic information and the data of said at least one communication point to the vehicle navigation device,

wherein said at least one communication point includes a point from which a detour route for taking a longer way around a place noted in the traffic information can be defined; and

the traffic information sent to the vehicle navigation device is a combination of detailed information about a section from the current or start position of the vehicle to selected one of said at least one communication point and simplified information about a section from the selected communication point to the destination.

According to the above structure, data of the communication point defined on the proposed travel route and the traffic information relating to the proposed travel route are sent to the vehicle navigation device, and the vehicle navigation device can calculate a travel route based on the received data. Therefore, map data relating to the proposed travel route and having a large data amount can be eliminated from the data sent to the vehicle navigation device, thereby reducing the burden on the memory of the vehicle navigation device.

In addition, the traffic information sent to the vehicle navigation device is a combination of detailed information about a section from the current or start position of the vehicle to selected one of said at least one communication point and simplified information about a section from the selected communication point to the destination. As a preferable example, the selected communication point is the closest communication point to the vehicle on the way to the destination. Regarding traffic information for the section up to the closest communication point, that is, for the section relatively close to the vehicle, necessity for detailed information is high. In contrast, regarding traffic information for the section from the closest communication point to the destination, that is, for the section relatively far from the vehicle, necessity for detailed information is low. Therefore, in the data sent to the vehicle navigation device, information which is essential is secured while the data amount of the traffic information itself is reduced. Therefore, the burden on the memory of the vehicle navigation device can be further reduced.

The updated traffic information is extracted from the traffic information storage device every time the vehicle passes through each communication point, and the updated traffic information is sent to the vehicle navigation device. Therefore, a travel route can be newly calculated based on the updated traffic information and map data stored in the vehicle navigation device, thereby making the vehicle navigation device calculate a suitable travel route. In addition, the communication point(s) are defined in a manner such that a point from which a detour can be defined (i.e., an intersection or a road branch) is included in the points. Therefore, it is possible to make the vehicle run on a detour route which can be defined according to the updated traffic information; thus, the sent traffic information can be effectively used.

In addition, the amount of the sent data is reduced; thus, the time necessary for the communication can also be reduced. Furthermore, frequency of interruption in communication while the vehicle is running is also reduced, thereby improving the quality of communication and performing comfortable navigation.

Typically, the traffic information stored in the traffic information storage device is obtained from an external traffic information center and is suitably updated so that substantially the newest traffic information is stored in the traffic information storage device.

As a typical example, said at least one communication point is defined in at least one of a section far from the current or start position of the vehicle by a predetermined distance and a section far from an area to which the vehicle can reach in a predetermined time. Accordingly, it is possible to make the vehicle navigation device calculate a suitable travel route while the cost necessary for the communication can be minimized.

The present invention also provides a vehicle navigation device (e.g., a vehicle navigation device 8 in the embodiment) built into a vehicle, wherein the vehicle navigation device uses a vehicle navigation server as explained above and comprises:

an arithmetic unit (e.g., an arithmetic unit 81 in the embodiment) for calculating a travel route to be defined, based on the current or start position and the destination of the vehicle, at least a portion of the traffic information received from the vehicle navigation server, and map data, where said at least a portion of the traffic information relates to a section from the current or start position to the closest communication point to the vehicle on the way to the destination; and

a memory (e.g., a memory 82 in the embodiment) for storing at least the data sent from the vehicle navigation server, the map data, and the calculated travel route.

According to this structure, map data, which relates to the proposed travel route and contains a large amount of data, can be deleted from the data sent from the vehicle navigation server; thus, it is possible to reduce the burden on the memory of the vehicle navigation device. In definition of the travel route, a passenger of the vehicle may choose a calculated travel route or automatic definition may be performed based on set conditions (e.g., the shortest (distance) route or a route giving priority to toll roads).

The present invention also provides a vehicle navigation system (e.g., a vehicle navigation system 1 in the embodiment) comprising a vehicle navigation server as explained above and a vehicle navigation device as explained above,

wherein when the vehicle navigation server detects that the vehicle has passed each communication point, the traffic information extracting device newly extracts from the traffic information storage device traffic information about a section between the relevant communication point and the destination of the proposed travel route stored in the data storage device, and the data sending device sends the newly extracted traffic information to the vehicle navigation device;

in the vehicle navigation device, the arithmetic unit calculates and defines a travel route from the current position to the destination of the vehicle, based on the received traffic information and the map data; and

data about the communication point which the vehicle has passed are deleted from the data storage device (e.g., the storage devices 16 to 18 in the embodiment) of the vehicle navigation server and the memory (e.g., the memory 82 in the embodiment) of the vehicle navigation device.

Accordingly, data about the communication point which the vehicle has passed are deleted so that storage capacity for necessary information can be secured, thereby performing more suitable route guiding operation.

In a preferable example, when one of a state that the vehicle has reached the destination, a state that the destination has been changed, and a state that the vehicle is out of the travel route calculated and defined in the vehicle navigation device is detected, setting of each communication point defined before this detection is released; and

data about the released communication point are deleted from the data storage device of the vehicle navigation server and the memory of the vehicle navigation device.

Accordingly, the definition of the communication point unnecessary for the vehicle and the vehicle navigation server is released and relevant data is deleted; thus, it is possible to prevent unnecessary information from being updated, and storage capacity for necessary information can be secured in the data storage device of the vehicle navigation server and the memory of the vehicle navigation device, thereby performing more suitable route guiding operation.

Typically, the vehicle navigation device is connected to the vehicle navigation server via a cellular phone and the Internet.

### BRIEF DESCRIPTION OF THE DRAWINGS

FIG. 1 is a diagram showing the general structure of the vehicle navigation system as an embodiment of the present invention.

FIG. 2 is a block diagram showing the structure of the navigation server in FIG. 1.

FIG. 3 is a process chart of the navigation operation of the vehicle navigation device in FIG. 1.

FIG. 4 is a process chart of the navigation operation of the navigation server in FIG. 1.

FIG. 5 is a diagram showing a travel route guided by the vehicle navigation system in FIG. 1.

FIG. 6 is also a diagram showing a travel route guided by the vehicle navigation system in FIG. 1.

### DESCRIPTION OF THE PREFERRED EMBODIMENTS

Hereinafter, a vehicle navigation server, a vehicle navigation device, and a vehicle navigation system as embodiments according to the present invention will be explained with reference to the drawings.

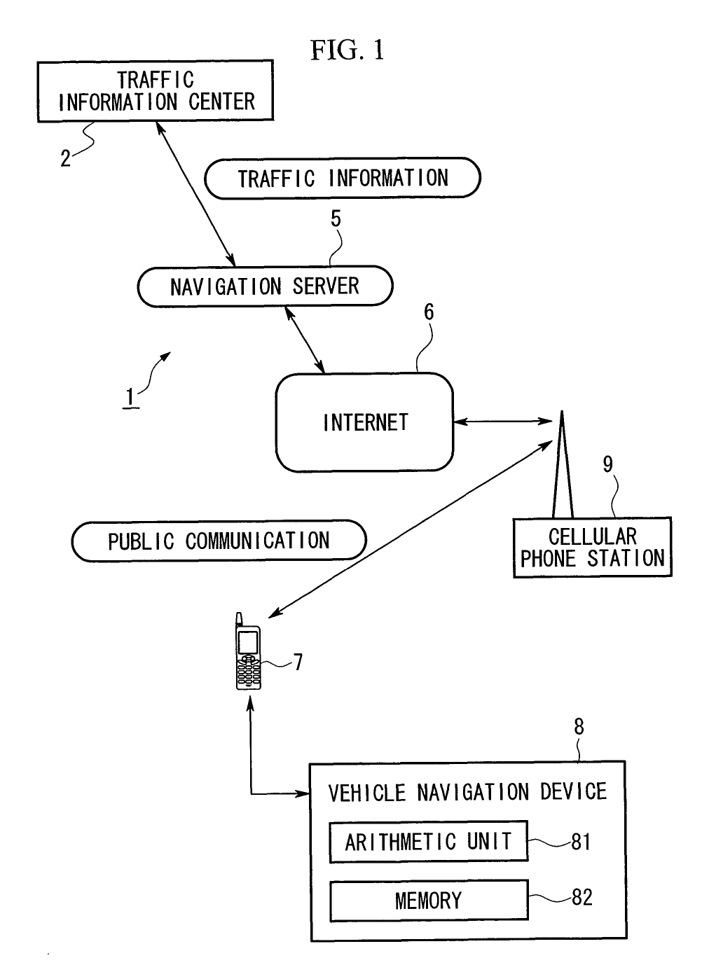

FIG. 1 is a diagram showing the general structure of the vehicle navigation system 1 as an embodiment of the present invention.

The vehicle navigation system 1 of the present embodiment has a (vehicle) navigation server 5 and a vehicle navigation device 8 which is built into a vehicle. Each structure will be explained below.

The navigation server 5 is connected to a traffic information center 2 and retrieves traffic information from the traffic information center 2 as needed, as explained below. The navigation server 5 is also connected to the Internet 6.

The vehicle navigation device 8 can send and receive data to and from the cellular phone station 9 via a cellular phone 7 which is a portable terminal for a passenger of the vehicle. The cellular phone station 9 is connected to the Internet 6, so that data transmission between the vehicle navigation device 8 and the navigation server can be performed.

The vehicle navigation device 8 has a GPS (global positioning system) antenna for determining the current position of the vehicle, a GPS receiver, a road map database, and a display screen, and the current position of the vehicle, detected by the GPS function, can be shown on the display screen.

The vehicle navigation device has an arithmetic unit 81 and a memory 82. The arithmetic unit 81 can calculate a travel route based on input travel conditions. The input travel conditions include the current or start position and the destination, and may include a position where the vehicle will pass and a priority route (e.g., a route giving priority to general roads or toll roads, and a route determined by giving priority to the distance or the width of the road). The memory 82 can store the road map database, the input data, and the calculated travel route, and can also store data sent from the navigation server 5.

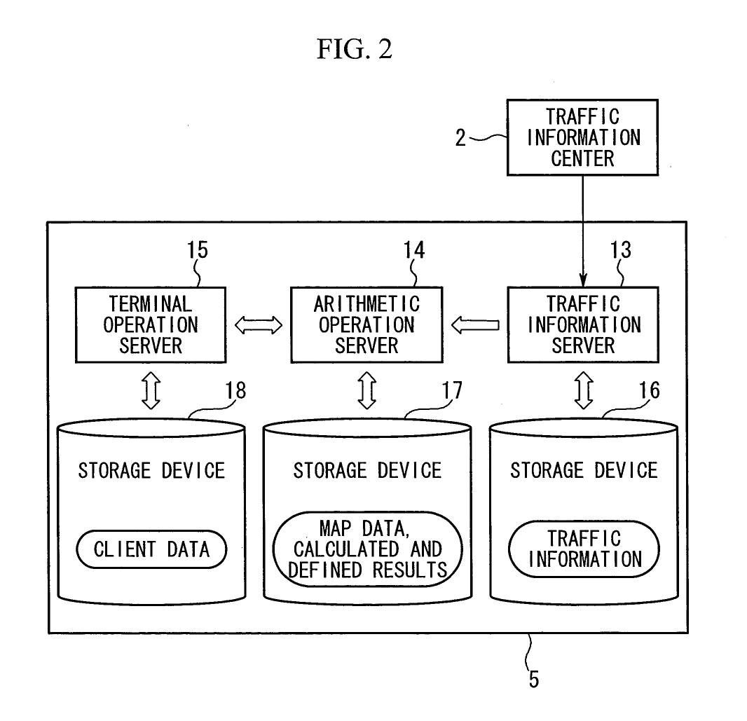

The navigation server 5 will be explained below. FIG. 2 is a block diagram showing the structure of the navigation server 5 in FIG. 1.

The navigation server 5 has a traffic information server 13, an arithmetic operation server 14, and a terminal operation server 15, to which storage devices 16, 17, and 18 are respectively connected.

The traffic information server 13 is connected to the traffic information center 2. The traffic information server extracts traffic information from the traffic information center 2 as needed and stores the extracted traffic information in the storage device 16 to which the server 13 is connected. The traffic information stored in the storage device 16 is updated every time the traffic information server 13 extracts traffic information from the traffic information center 2, so that substantially the newest traffic information is stored in the storage device 16.

The terminal operation server 15 is connected to the vehicle navigation device 8 via the Internet 6, so that data transmission between the terminal operation server 15 and the vehicle navigation device 8 is performed. In the storage device 18 connected to the terminal operation server 15, identification data of clients (i.e., registrants) and the like are stored.

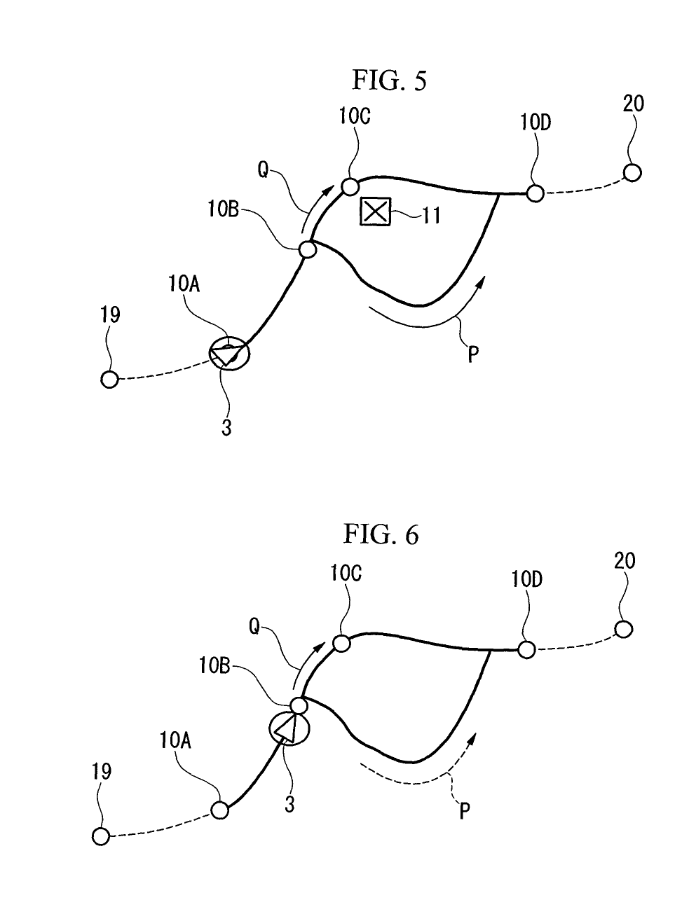

The arithmetic operation server 14 is connected to the terminal operation server 15 and the traffic information server 13. Based on the input data from a client, which the terminal operation server 15 received, a proposed travel route is calculated. In the next step, traffic information relating to the calculated travel route is retrieved from the traffic information server 13. The arithmetic operation server 14 also defines communication points 10 (see FIGS. 5 and 6) on the proposed travel route, where the traffic information for the proposed travel route is updated at each communication point 10. This function will be explained below in detail. The arithmetic operation server 14 is connected to the storage device 17 in which map data and calculated and defined results are stored.

The operation of the vehicle navigation system 1 having the above-explained structure will be explained below.

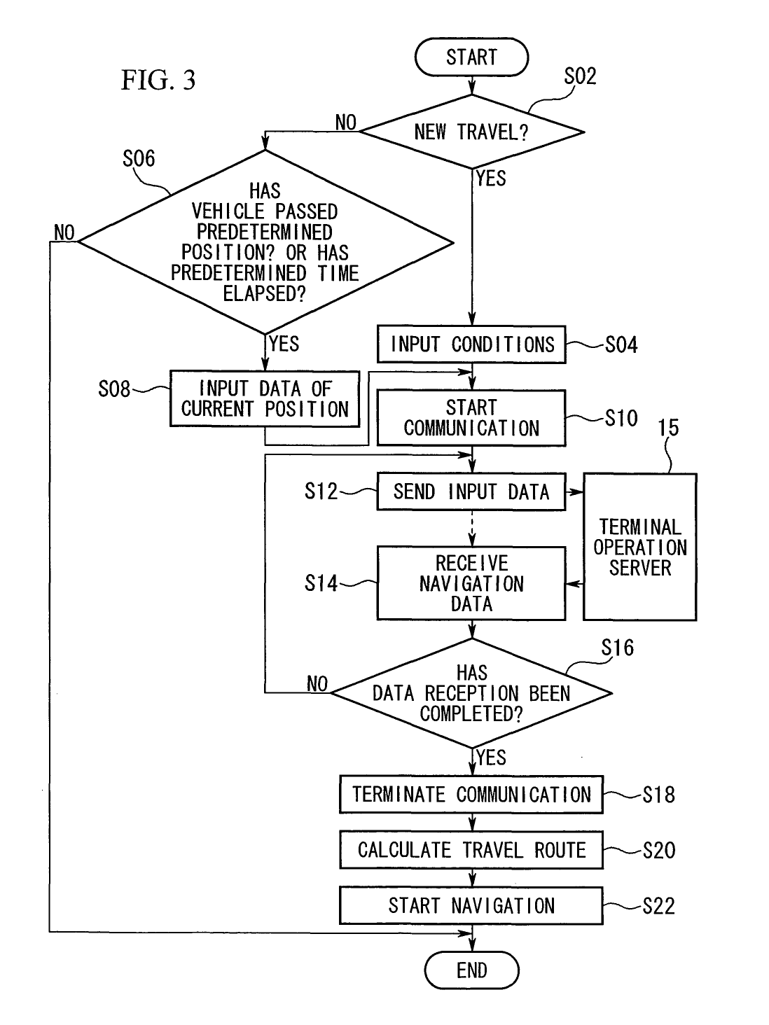

FIG. 3 is a process chart of the navigation operation of the vehicle navigation device 8. In the first step S02, it is determined whether the target is a new travel to which no travel guide has been assigned. If the result of the determination is “YES” (i.e., a new travel), the operation proceeds to step S04, while if the result of the determination is “NO” (i.e., not a new travel), the operation proceeds to step S06. In step S04, the above-explained travel conditions are input into the memory 82 of the vehicle navigation device 8, and the operation proceeds to step S10.

In step S06, it is determined whether the vehicle has passed a predetermined position (corresponding to the communication point 10 explained below) or a predetermined time has elapsed. If the result of the determination of step S06 is “YES”, the operation proceeds to step S08, while if the result of the determination is “NO”, the operation is terminated for the present. In step S08, data of the current position detected by the vehicle navigation device by using the GPS function is input into the memory 82, and the operation proceeds to step S10.

In step S10, the cellular phone 7 connected to the vehicle navigation device 8 is operated so as to connect to the Internet 6 via the cellular phone station 9 and to start communication. In the following step S12, the input data (data related to step S04 or S08, that is, the new travel or the current position) is sent to the terminal operation server 15 of the navigation server 5.

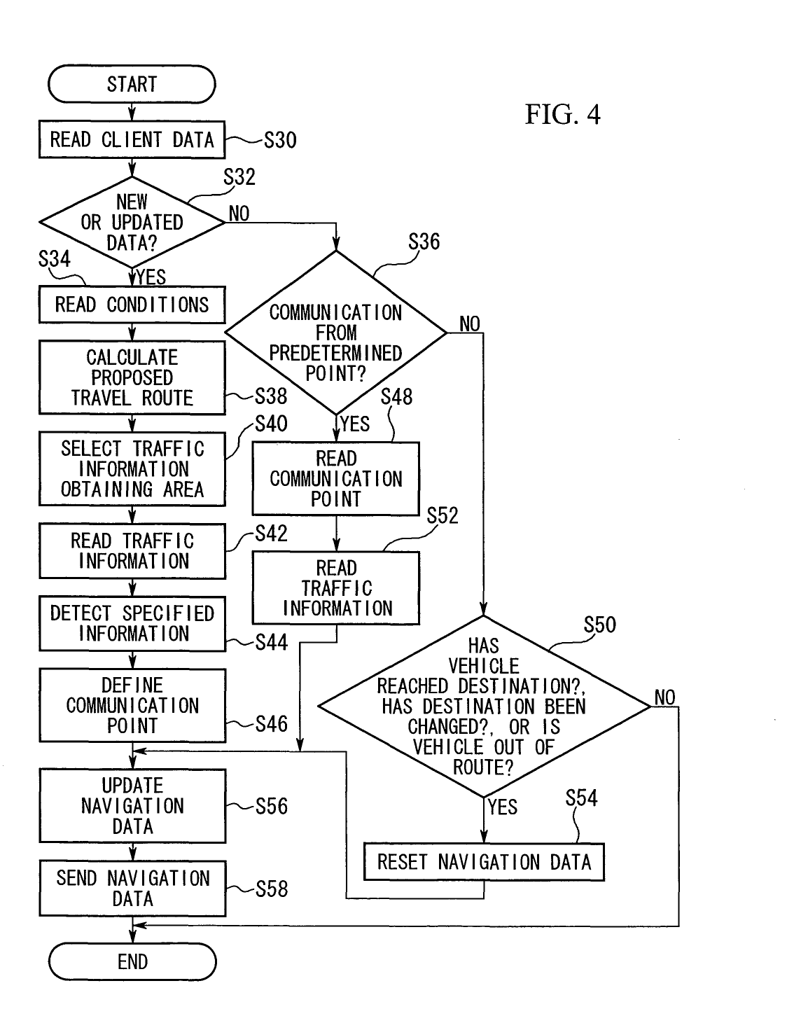

Based on the received data, the terminal operation server 15 executes the following operation. FIG. 4 is a process chart of the navigation operation performed by the navigation server 5. In the first step S30, client data of the relevant client is read by the terminal operation server 15.

The client data is authentication data such as an identification number and a password for identifying a registered client. That is, the client who sent data is identified by reading the client data, and the arithmetic operation server 14 performs the following operation.

First, in step S32, it is determined whether the input travel conditions are new or updated data, that is, whether a proposed travel route should be calculated. If the result of the determination is “YES”, the operation proceeds to step S34, while if the result of the determination is “NO”, the operation proceeds to step S36.

In step S34, the travel conditions sent from the client are read and stored in the storage device 17 connected to the arithmetic operation server 14. In the following step S38, a route for satisfying the travel conditions is calculated by the arithmetic operation server 14, where at least one proposed travel route is calculated. In the following step S40, a traffic information obtaining area including the calculated proposed travel route is selected. In the next step S42, traffic information in the traffic information obtaining area is extracted and is read from the traffic information center 2 via the traffic information server 13.

In the next step S44, specified information (e.g., traffic jam information or accident information) is detected from the extracted traffic information. In step S46, communication points 10 are defined. Each communication point 10 is defined on the proposed travel route, and when the vehicle passes the point 10, communication with the traffic information center 2 is performed so as to newly extract traffic information for the remaining route to the destination. The communication points 10 are defined in a manner such that a point from which a detour can be defined (i.e., an intersection or a road branch) is included in the points 10.

Typically, each communication point is defined in a section far from the current or start position of the vehicle by a predetermined distance or in a section far from an area to which the vehicle can reach in a predetermined time.

In the following step S56, navigation data is updated. Here, the traffic information for the calculated proposed travel route and data of the communication points 10 are input as navigation data. In the next step S58, the navigation data is sent from the terminal operation server 15 to the vehicle navigation device 8, and the operation of the navigation server 5 is terminated. Here, detailed (traffic) information is provided for the section between the current position or the start point 19 (the start position 19 is employed if the vehicle has not yet started) of the vehicle 3 (refer to FIG. 5 which shows four communication points 10 (i.e., 10A to 10D)) and the closest communication point 10 to the vehicle 3 on the way to the destination 20 (i.e., the communication point 10B in the case shown in FIG. 5), and simplified (traffic) information is provided for the section between the closest communication point and the destination.

In the vehicle navigation device 8, the navigation data including the traffic information is received (see step S14 of FIG. 3). In the following step S16, it is determined whether the data reception has been completed. If the result of the determination is “YES”, the operation proceeds to step S18, where the communication is terminated. In this case, the navigation data is stored in the memory 82 of the vehicle navigation device 8. If the result of the determination is “NO”, the operation returns to step S12, and the above-explained communicating operation is repeated.

In step S20, a travel route is calculated in the vehicle navigation device 8. In the calculation, the arithmetic unit 81 calculates and defines a travel route based on (i) the current or start position and the destination of the vehicle, (ii) at least a portion of the traffic information received from the vehicle navigation server 5, and (iii) map data stored in the memory 82. The portion of the traffic information relates to a section from the current or start position to the closest communication point to the vehicle on the way to the destination. In the calculation, the navigation data is considered, thereby calculating a suitable travel route. For example, as shown in FIG. 5, if traffic information including a traffic accident place 11 is stored as navigation data for the shortest route (see arrow Q) from the start point 19 to the destination 20, a detour route (see arrow P) can be defined so as to take a longer way around the accident scene 11.

In step S22, navigation based on the determined route is started, and the operation of a series of the above-explained steps is suspended.

As explained above, map data relating to the proposed travel route and having a large data amount can be eliminated from the data sent to the vehicle navigation device 8, thereby reducing the burden on the memory 82 of the vehicle navigation device 8.

In addition, regarding traffic information for the section up to the closest communication point, that is, for the section relatively close to the vehicle 3, necessity for detailed information is high. In contrast, regarding traffic information for the section from the closest communication point to the destination, that is, for the section relatively far from the vehicle 3, necessity for detailed information is low. Therefore, in the data sent to the vehicle navigation device 8, information which is essential is secured while the data amount of the traffic information itself is reduced. Therefore, the burden on the memory 82 of the vehicle navigation device 8 can be further reduced.

When the vehicle 3 runs along the travel route and passes each communication point (e.g., communication point 10B), the navigation operation as shown in FIGS. 3 and 4 is started again. In this case, the result of the determination of step S32 of FIG. 4 is “NO”, and in step S36, it is determined whether the communication has been performed from a predetermined point (i.e., the communication point 10). If the result of the determination is “YES”, the operation proceeds to step S48, while if the result of the determination is “NO”, the operation proceeds to step S50.

In step S48, data of the communication point (e.g., the communication point 10B) which the vehicle 3 has passed is read, and in the following step S52, traffic information relating to an area from this communication point to the destination is extracted from the traffic information center 2 via the traffic information server 13, and the traffic information stored in the storage device 16 is updated. In the next step S56, the navigation data is updated to employ the newly obtained traffic information, and the following necessary steps as explained above are performed. Here, data relating to the communication point which the vehicle has already passed (in this case, the communication point 10B), that is, data unnecessary for the vehicle 3 and the navigation server 5, is deleted, thereby securing a sufficient area for storing necessary information. Accordingly, more suitable and preferable travel guiding operation can be performed.

Additionally, as shown in FIG. 6, the communication point 10B is set at a point where a detour route (for taking a longer way around the determined (shortest) route) can be defined. Therefore, if information indicating that the accident information at the accident scene has been eliminated is obtained when the vehicle passes the communication point 10B, the travel route can be switched from the detour route (see the arrow P) to the shortest route (see the arrow Q). Accordingly, the travel route can be newly calculated and changed based on the updated traffic information, thereby effectively using the traffic information sent to the vehicle navigation device 8.

In step S50, it is determined whether one of the following states is detected: (i) the vehicle 3 has reached the destination 20, (ii) the destination has been changed and thus the route guiding operation has been terminated, and (iii) the vehicle 3 is out of the determined travel route. If the result of the determination is “YES”, the operation proceeds to step S54. If the result of the determination is “NO”, the operation proceeds to step S14, and the subsequent steps are performed.

In step S54, the navigation data is reset or cleared, and in step S56, definition of the communication points 10 before arrival or changing of the destination or the route is released and data of the communication points 10 are deleted from the storage devices 16 to 18 of the navigation server 15 and the memory 82 of the vehicle navigation device 8. Accordingly, it is possible to prevent unnecessary information from being updated, and storage capacity for necessary information can be secured, thereby performing more suitable route guiding operation.

In the above-explained embodiment, the communication points 10 are calculated and determined by the navigation server 5. However, this is not a limiting condition and the communication points 10 may be calculated and determined by the vehicle navigation device 8. In addition, a passenger of the vehicle may determine the communication points 10. In this case, based on the experiences of the passenger, the communication points can be defined on points where a traffic jam may probably occur; thus, the experiences of the passenger can be effectively used.

What is claimed is:

1. A vehicle navigation server comprising:
a travel route calculating device for calculating at least one proposed travel route of a vehicle based on data input by a registrant to the server, the data including a current or start position and a destination of the vehicle;
a traffic information extracting device for extracting traffic information relating to the proposed travel route from a traffic information storage device;
a communication point setting device for defining at least one communication point on the proposed travel route, so as to newly extract traffic information for an area from each communication point to the destination from the traffic information storage device and to send the newly extracted traffic information to a vehicle navigation device built in the vehicle when the vehicle passed the communication point;
a data storage device for storing at least data for identifying the registrant, data of said at least one proposed travel route, and data of said at least one communication point, and
a data sending device for sending at least the traffic information and the data of said at least one communication point to the vehicle navigation device,
wherein said at least one communication point includes a point from which a detour route for taking a longer way around a place noted in the traffic information can be defined; and
the traffic information sent to the vehicle navigation device is a combination of detailed information about a section from the current or start position of the vehicle to selected one of said at least one communication point and simplified information about a section from the selected communication point to the destination.

2. A vehicle navigation server as claimed in claim 1, wherein the traffic information stored in the traffic information storage device is obtained from an external traffic information center and is suitably updated so that substantially the newest traffic information is stored in the traffic information storage device.

3. A vehicle navigation server as claimed in claim 1, wherein the selected communication point is the closest communication point to the vehicle on the way to the destination.

4. A vehicle navigation server as claimed in claim 1, wherein said at least one communication point is defined in at least one of a section far from the current or start position of the vehicle by a predetermined distance and a section far from an area to which the vehicle can reach in a predetermined time.

5. A vehicle navigation device built into a vehicle, wherein the vehicle navigation device uses a vehicle navigation server as claimed in claim 1 and comprises:
an arithmetic unit for calculating a travel route to be defined, based on the current or start position and the destination of the vehicle, at least a portion of the traffic information received from the vehicle navigation server, and map data, where said at least a portion of the traffic information relates to a section from the current or start position to the closest communication point to the vehicle on the way to the destination; and
a memory for storing at least the data sent from the vehicle navigation server, the map data, and the calculated travel route.

6. A vehicle navigation system comprising a vehicle navigation server as claimed in claim 1, the system further comprising:
a vehicle navigation device built into a vehicle, where the vehicle navigation device uses the vehicle navigation server and comprises:
an arithmetic unit for calculating a travel route to be defined, based on the current or start position and the destination of the vehicle, at least a portion of the traffic information received from the vehicle navigation server, and map data, where said at least a portion of the traffic information relates to a section from the current or start position to the closest communication point to the vehicle on the way to the destination; and
a memory for storing at least the data sent from the vehicle navigation server, the map data, and the calculated travel route,
wherein when the vehicle navigation server detects that the vehicle has passed each communication point, the traffic information extracting device newly extracts from the traffic information storage device traffic information about a section between the relevant communication point and the destination of the proposed travel route stored in the data storage device, and the data sending device sends the newly extracted traffic information to the vehicle navigation device;
in the vehicle navigation device, the arithmetic unit calculates and defines a travel route from the current position to the destination of the vehicle, based on the received traffic information and the map data; and
data about the communication point which the vehicle has passed are deleted from the data storage device of the vehicle navigation server and the memory of the vehicle navigation device.

7. A vehicle navigation system as claimed in claim 6, wherein:
when one of a state that the vehicle has reached the destination, a state that the destination has been changed, and a state that the vehicle is out of the travel route calculated and defined in the vehicle navigation device is detected, setting of each communication point defined before this detection is released; and
data about the released communication point are deleted from the data storage device of the vehicle navigation server and the memory of the vehicle navigation device.

8. A vehicle navigation system as claimed in claim 6, wherein the vehicle navigation device is connected to the vehicle navigation server via a cellular phone and the Internet.
